(19) United States
(12) Patent Application Publication
(10) Pub. No.: US 2014/0321142 A1
(43) Pub. Date: Oct. 30, 2014

(54) MOTOR VEHICLE HEADLAMP MODULE FOR ILLUMINATING THE ROAD

(71) Applicant: Pierre Albou, Paris (FR)

(72) Inventor: Pierre Albou, Paris (FR)

(73) Assignee: Valeo Vision, Bobigny Cedex (FR)

(21) Appl. No.: 14/241,609

(22) PCT Filed: Sep. 13, 2012
(86) PCT No.: PCT/EP2012/067892

§ 371 Date: May 23, 2014

(30) Foreign Application Priority Data
Sep. 13, 2011 (FR) 1158100

(51) Int. Cl. F21S 8/10

(52) U.S. Cl. CPC F21S 48/1225; F21S 48/13
USPC 362/516

(57) ABSTRACT

A module for a headlamp for a motor vehicle, this module comprising a concave reflector, a light source arranged in the concave region of the reflector and an exit lens exhibiting a median line on its exit surface forming a space curve, wherein the exit lens and the reflector are arranged in such a way that a light beam reflected by the reflector is directly refracted by the exit lens in such a way as to generate a beam of light for lighting the road.

### CROSS-REFERENCE TO RELATED APPLICATIONS

This application claims priority to PCT Application PCT/EP2012/067892 filed Sep. 13, 2012, and also to French Application No. 1158100 filed Sep. 13, 2011, which are incorporated herein by reference and made a part hereof.

### BACKGROUND OF THE INVENTION

1. Field of the Invention

The invention relates to a motor vehicle headlamp module intended for lighting the road, this module including a concave reflector, a light source arranged in the concave region of the reflector and a lens directly refracting the rays of light reflected by the reflector.

2. Description of the Related Art

Developments in vehicle styles have led to headlamps having housings equipped with outer lenses the surface of which follows a space curve, varying in three dimensions, subsequently designated mean or median line. It is then desirable, particularly for reasons of style, for the lens of the headlamp, which lens is arranged in the housing behind one such outer lens, to follow the space curve of the outer lens as closely as possible.

Patent application EP 1936260, from VALEO VISION, published Jun. 25, 2008, which is equivalent to U.S. Patent Publication 2008015167 and to U.S. Pat. No. 7,934,861, describes a method for fabricating lighting modules of this type, which allow, by juxtaposition of the ends of the exit lenses, a headlamp to be produced, the overall exit surface area of which is continuous and smooth and follows a space curve as median or mean line. In other words, the mean line of the lenses of these headlamps extends in three dimensions.

Nonetheless, this method for determining the shape of the exit lenses, which form an overall lens for the headlamp when they are juxtaposed, is limited in that it imposes the condition that each exit lens has one and the same section on the vertical plane.

Notably a lens generated according to this method has a toroid shape, with a width greater than its height, which can be unsatisfactory for some styles of bodywork.

In other words, the overall lens does not completely follow the style curve in the absence of a twisted shape translating the variation of this style curve in the three spatial dimensions.

Moreover, the lighting modules described in the application EP1936260 require many optical elements, notably deflectors, which make their fabrication relatively expensive.

Finally, such a method is limited to the implementation of position lights, generating a horizontally sectioned beam using a stigmatic optical system.

### SUMMARY OF THE INVENTION

The present invention aims to alleviate at least one of the problems mentioned above. This is why the invention concerns a headlamp module for a motor vehicle, this module comprising a concave reflector, a light source arranged in the concave region of the reflector and an exit lens exhibiting a median line on its exit surface forming a space curve, characterized in that the exit lens and the reflector are arranged in such a way that a light beam reflected by the reflector is directly refracted by the exit lens in such a way as to generate a beam of light for lighting the road.

Using this invention, a headlamp module can be fabricated with a limited number of optical elements, which are notably reduced to a light source, a reflector and a lens. Thus, the fabrication cost of such a headlamp is reduced with respect to a headlamp of the prior art which requires additional elements, such as deflectors.

In addition, the invention makes it possible to fabricate modules provided with exit lenses that follow the shape of a space curve in its three dimensions, contrary to a lens of the prior art which was fabricated by translation of a same vertical section.

In one embodiment, the module comprises the exit lens and the reflector that are arranged in such a way that the light beam directly refracted by the lens forms a cylindrical wave surface.

According to one embodiment, the module comprises the exit lens and the reflector that are arranged in such a way that the position of the axis of the cylindrical wave surface of the directly refracted light beam determines a height and an aperture of said directly refracted light beam.

According to one embodiment, the reflector and the lens form a system with a focal point, the reflector being arranged in such a way that, for any given point of the reflector, the optical path up to the axis of said cylindrical wave surface corresponding to a ray coming from said focal point passing through this given point of the reflector then emerging at a point on the exit surface of the lens, is constant.

In one embodiment, the module comprises the directly refracted light beam that is a beam of high beam type, i.e. a beam intended to light the road.

According to one embodiment, the module comprises the exit lens that exhibits a vertical section that is variable along the space curve.

In one embodiment, the module comprises the exit lens that exhibits identical sections on various planes of construction defined such that each plane of construction, comprising a point M on the space curve, is perpendicular to a vector tangent to said space curve.

According to one embodiment, the module comprises the reflector and the light source that are arranged in such a way that a beam of light coming from the light source is directly reflected by the reflector toward the lens.

The invention also concerns an elementary optical lens able to be used as the exit lens of a module according to one of the preceding embodiments, said lens comprising an exit surface following a space curve median, sections of the lens at several points on this space curve median in planes perpendicular to the space curve median being superimposable by translational and/or rotational movement without deformation.

In one embodiment, the elementary optical lens forms a stigmatic optical system in the various planes perpendicular to the space curve median.

In one embodiment, the elementary optical lens exhibits a spherical entrance surface of constant radius in the various planes perpendicular to the space curve median.

The invention also concerns a module according to one of the preceding embodiments wherein the exit lens is an elementary optical lens according to one of the preceding embodiments.

Thus, the beam coming from a module in accordance with the invention can be used as a high beam, i.e. a beam intended to light the path of a vehicle.

The invention also concerns an optical lens with portions formed by several elementary optical lenses in accordance with one of the preceding embodiments. One such overall lens, formed by exit lenses according to the invention, follows the shapes desired by the stylists as closely as possible and exhibits a twisted shape close to the space shape of the style curve

In one embodiment, the optical lens with portions comprises an overall exit face:

formed by exit faces of various elementary optical lenses, and

comprising an overall median curve formed by the median curves of the various elementary lenses.

According to one embodiment, the optical lens with portions exhibits an overall exit surface that is continuous and smooth.

Other advantages of the invention will become apparent in the light of the description of an embodiment of the invention given below, by way of illustration and non-limiting example, with reference to the attached figures in which:

### BRIEF DESCRIPTION OF THE ACCOMPANYING DRAWINGS

FIG. 1 is a schematic front view of the front-left outside edge of a vehicle equipped with a headlamp according to the invention;

FIG. 2 is a perspective view of the optical system employed by the headlamp in FIG. 1;

FIGS. 3 to 7 are diagrams representing geometrical relationships at the surface of a lens or of a reflector in the process of being designed according to the invention; and

FIGS. 8 to 11 are diagrams representing Isolux curves obtained from a headlamp in accordance with an embodiment of the invention.

### DETAILED DESCRIPTION OF THE PREFERRED EMBODIMENTS

In the description below, identical elements or elements performing a similar function bear the same references in the various figures.

With reference to FIG. 1, the front-left end of a vehicle 100 equipped with a headlamp 102 according to the invention exhibits an overall lens 104 the shape of which follows a space curve 106, i.e. a curve varying in its three dimensions with respect to a reference frame (O, x, y, z) that is fixed with respect to the vehicle 100, notably defining the vertical (Oz).

This space curve 106 is substantially parallel to a style curve 108 of the outer lens 104 of the headlamp 102 in order to be coherent with a style of the bodywork of the vehicle 100.

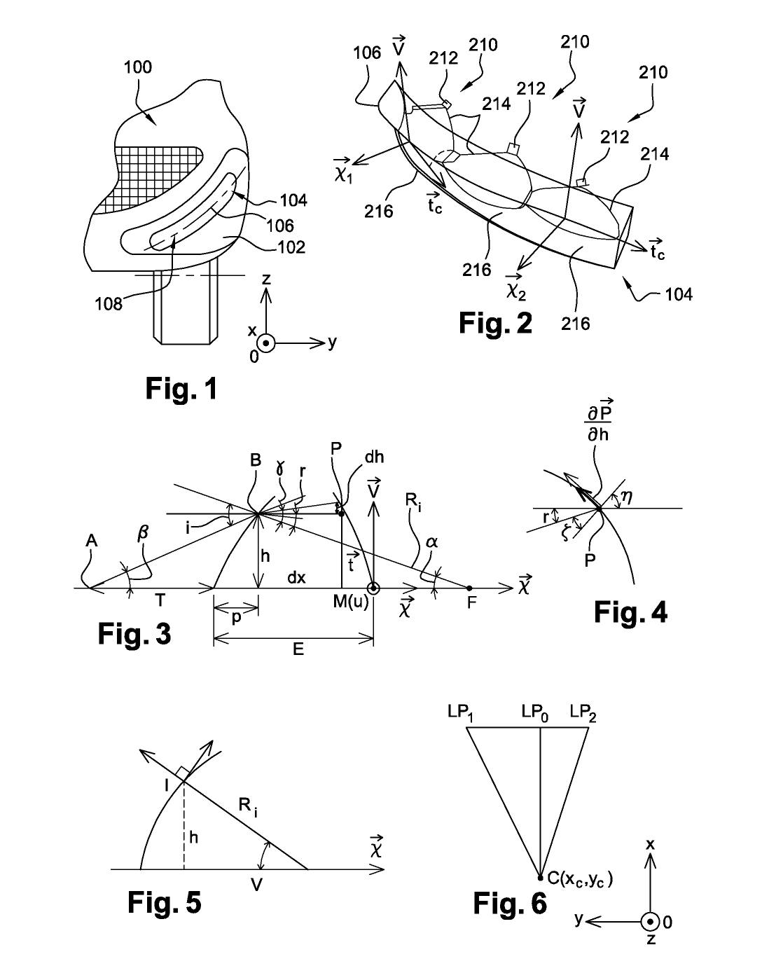

With reference to FIG. 2, the headlamp 102 is composed of three juxtaposed modules 210, it being understood that a headlamp 102 in accordance with the invention is not limited to this number of juxtaposed modules 210. In other words, a headlamp 102 in accordance with the invention can be formed by n modules 210, n typically lying between 1 and 10 and in particular between 2 and 4.

Each module 210 comprises a light source 212 formed by at least one light-emitting diode intended to send light toward a reflector 214 in order for the latter to reflect light rays coming from this source 212 toward an exit lens 216.

The exit lens 216 and the reflector 214 are arranged in such a way that a light beam reflected by the reflector 214 is directly refracted by the exit lens 216, i.e. without being modified by a third optical element. Thus, the number of optical elements needed to equip the headlamp 102 is limited to the light source 212, the reflector 212 and the exit lens 216.

The exit lenses 216 are juxtaposed in such a way as to form the overall lens 104 exhibiting a, continuous and smooth, exit surface able to generate the high beam. With this aim, the design of each module 210 comprises two first successive steps using a local reference frame imposed by the space curve 106, namely:

a first step of designing each exit lens 216; and

a second step of designing the reflector 214 based on the exit lens 216 obtained in the first step.

These two steps are detailed below using the expressions “front” or “upstream” and “back” or “downstream”, which are to be understood with respect to the direction of propagation of the light beam emitted by the light source 212, reflected by the reflector 214 then refracted by the exit lens 216.

Moreover, in these two steps, the space curve 106 of the exit lens 216, which corresponds to a median line of the exit surface of the overall lens 104, is modeled by a function M(u) such that the coordinates of a point M on the space curve 106 in the reference frame (O, x, y, z) that is fixed vis-à-vis the vehicle 100 is:

$$M ( u ) = ( \begin{matrix}{x}_{M} ( u ) \\ {y}_{M} ( u ) \\ {z}_{M} ( u )\end{matrix} )$$

Where u is a parameter chosen from any interval and M(u) is a doubly differentiable function.

In fact, the first and second derivatives of the function M(u) are required to construct the orthonormal local reference frame, the orientation of which at a point M follows the variations of the space curve 106 at this point M, implemented for the design of the exit lens 216.

Thus the determination of the shape of the exit lens 216 in the local reference frame takes into account the variations of the space curve 106 in three dimensions at each point M(u).

These first or second derivatives are written, for example for the horizontal coordinates x_{M}(u) along the x-axis, x′_{M}(u) or x″_{M}(u) where:

$${x}_{M}^{′} = \frac{d {x}_{M}}{d u} ( u ) ;$$

$${x}_{M}^{″} = \frac{{d}^{2} {x}_{M}}{d {u}^{2}} ( u )$$

In the absence of a known function M(u) for defining a space curve 106, this function M(u) can be obtained by modeling the space curve 106 by a polynomial function, for example using Bézier curves, using a plurality of points M, the coordinates of which are taken empirically.

### First Step Relating to the Design of the Lens:

For a given value of the parameter u and, as a corollary, for a point M, a local reference frame and the edges of the exit lens 216 are determined using a vector \vec{t}_{c} tangent to the space curve M(u) at this point M such that:

$${\vec{t}}_{c} = \frac{d \vec{OM}}{d u}$$

In such a way that its coordinates are written:

$${\vec{t}}_{c} = ( \begin{matrix}{x}_{M}^{′} \\ {y}_{M}^{′} \\ {z}_{M}^{′}\end{matrix} )$$

From such a tangent vector \vec{t}_{c}, it is possible to determine the local orthonormal reference frame, situated at M(u), comprising said tangent vectors \vec{t}_{c} and vectors \vec{χ} and \vec{V} such that:

the vector defines the first axis of the local reference frame according to the following cross product:

$$\vec{χ} = \frac{\vec{z} ⋀ {\vec{t}}_{c}}{‖ \vec{z} ⋀ {\vec{t}}_{c} ‖}$$

In such a way that its coordinates are written:

$$\vec{χ} = \frac{1}{\sqrt{{x}_{M}^{′2} + {y}_{M}^{′2}}} ( \begin{matrix}- {y}_{M}^{′} \\ {x}_{M}^{′} \\ 0\end{matrix} )$$

The vector \vec{χ} is perpendicular, on the one hand, to the vertical axis z of the fixed reference frame and, on the other hand, to the tangent vector \vec{t}_{c}.
the vector \vec{V} defines the second axis of the local reference frame according to the following cross product:

$$\vec{V} = \frac{\vec{t}}{‖ {\vec{t}}_{c} ‖} ⋀ \vec{χ}$$

In such a way that its coordinates are written:

$$\vec{V} = \frac{1}{\sqrt{( {x}_{M}^{′2} + {y}_{M}^{′2} ) ( {x}_{M}^{′2} + {y}_{M}^{′2} + {z}_{M}^{′2} )}} ( \begin{matrix}- {z}_{M}^{′} {x}_{M}^{′} \\ - {z}_{M}^{′} {y}_{M}^{′} \\ {x}_{M}^{′2} + {y}_{M}^{′2}\end{matrix} )$$

In the local reference frame (M, \vec{χ}, \vec{V}, \vec{t}_{c}), the exit lens 216 is then defined as a stigmatic lens of optical axis \vec{χ}, exhibiting a spherical entrance surface of radius Rᵢ, of summit M(u), of thickness at the centre E, of focal length T and material of index n, these parameters Rᵢ, E, n, and T being independent of u.

The calculation of the shape of the exit lens 216 is then carried out as a function of a parameter making it possible to scan the surface of the exit lens 216, such as the impact height h on the entrance face.

With reference to FIG. 3 and considering a ray coming from the focal point F, these conditions and the geometrical relationships between the incident, refracted or reflected beam or beams translate into the following equalities:

$$sin ( α ) = \frac{h}{{R}_{i}} ;$$

$$sin ( i ) = n sin ( γ ) ;$$

$$tan ( β ) = \frac{h}{T + ρ} ;$$

$$ρ = {R}_{i} - \sqrt{{R}_{i}^{2} - {h}^{2}} ;$$

$$r = γ - α ;$$

$$i = α + β$$

Considering the length l of a ray reflected in the exit lens 216 as a calculation parameter, it appears that a displacement dh along the axis defined by the vector \vec{V} or dx along the axis defined by the vector \vec{χ} translates into:

l·sin(r)=dh and l·cos(r)=dx

By writing the equality of two optical paths between two beams:

A̅B̅+n· B̅P̅+dist(P,(M ,\vec{V}))=T+n·E

Where dist(P,(M,V)) is the distance from the point P to a line passing through the point M and collinear with the vector \vec{V}, a parametric equation in (u,h) of the entrance and exit faces of the exit lens 216 is then obtained:

\sqrt{(T+ρ)²+h²}+n·l+(E−dx−ρ)=T+nE

From which: l·(n−cos r)=T+(n−1)E+ρ−\sqrt{(T+ρ)²+h²}

From this last equation, it is possible to define l, then dh and dx, as a function of h and of E. This being the case, the coordinates of a point P of the exit lens 216, and as a consequence the profile of the latter, are obtained by the following equation:

P=M(u)+(h+dh)·\vec{V}+(ρ+dx−E)·\vec{χ}

### Second Step Relating to the Design of the Reflector:

In the scenario of a point source placed at the point F, the beam emerging from the optical system formed by the reflector and the exit lens 216 exhibits the shape of a cylindrical wave surface of vertical axis C(z) the coordinates of which are:

$$( C = ( \begin{matrix}{x}_{C} \\ {y}_{C} \\ 0\end{matrix} ) , \vec{z} )$$

A modification of the position of this axis C(z) with respect to the exit surface of the exit lens 216 makes it possible to modify the spread, or the aperture, of the beam and its mean horizontal direction.

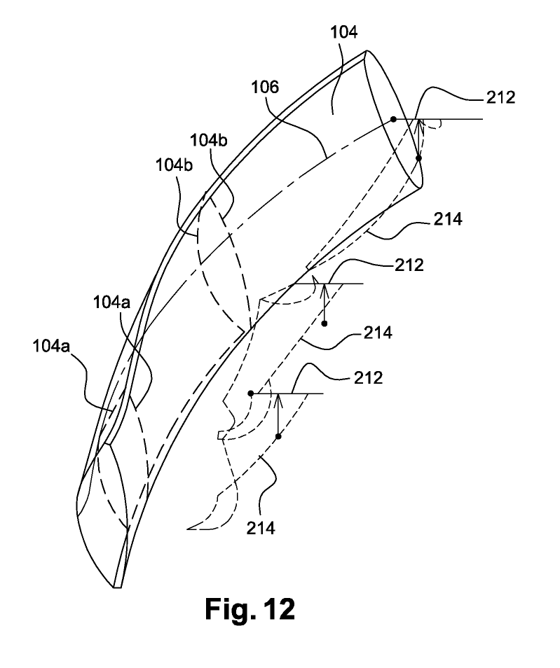

By way of example FIGS. 8, 9 and 10 represent Isolux curves representing the spatial distribution of the luminous intensity levels of a beam generated by various modules having various apertures and mean horizontal directions thus obtained.

Using such modules, it is then possible to obtain a high beam combining the properties of these various modules from a headlamp formed by these three modules (FIG. 11).

To determine a module, two points LP1 and LP2 of the space curve 106 delimiting the lens 216, as shown in FIG. 6, are considered. For a mean direction H_{dev} and a horizontal aperture Hₒᵤᵥ of the beam, it appears that:

$$tan {H}_{dev} = \frac{{y}_{c} - {y}_{LP 0}}{{x}_{LP 0} - {x}_{c}} , \\ arctan ( \frac{{y}_{LP 1} - {y}_{c}}{{x}_{LP 1} - {x}_{c}} ) + arctan ( \frac{{y}_{C} - {y}_{LP 2}}{{x}_{LP 2} - {x}_{c}} ) = {H}_{ouv}$$

Where LPₒ is defined as the middle of the segment [LP1; LP2], this segment modeling the space curve 106 for the calculation.

When the direction H_{dev} and the horizontal aperture Hₒᵤᵥ are fixed, the position of the axis C(z) is therefore determined and the shape of the reflector can also be fixed.

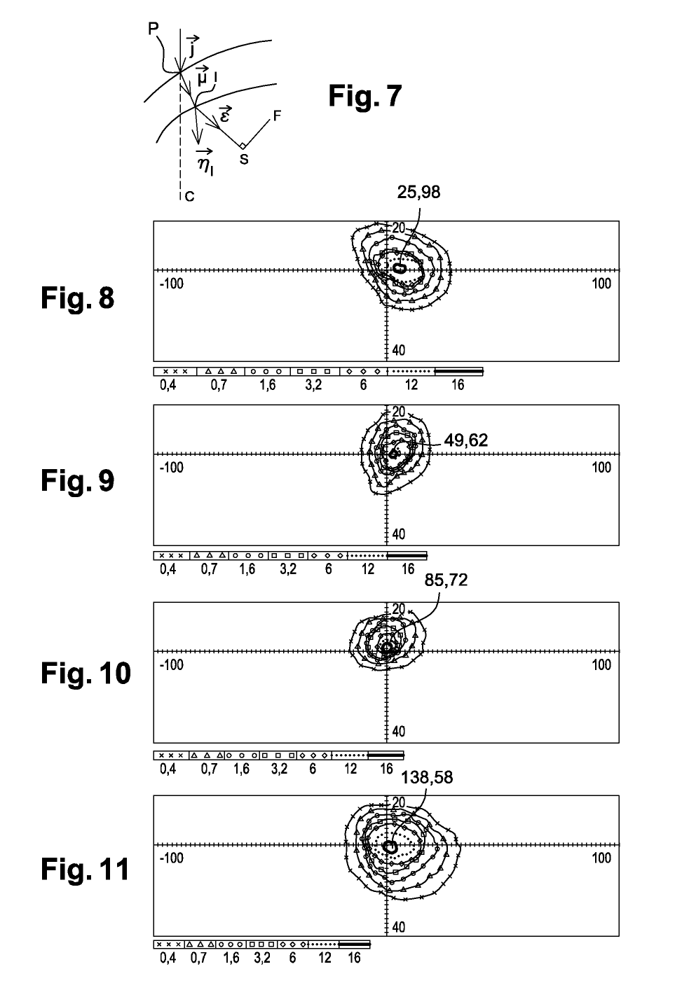

We will now consider the reverse path of the emitted beam represented by a ray \vec{j} normal to the exit wave surface which meets the exit surface of the exit lens 216 at the point P(u,h) (FIG. 7).

In this case, the coordinates of the vector \vec{j} are:

$$\vec{j} = \frac{signum ( {x}_{p} - {x}_{c} )}{\sqrt{{( {x}_{C} - {x}_{p} )}^{2} {( {y}_{c} - {y}_{p} )}^{2}}} \vert \begin{matrix}{x}_{c} - {x}_{p} \\ {y}_{c} - {y}_{p} \\ 0\end{matrix} \vert$$

The signum function is involved because, as a function of the position of the axis C(z) in front/upstream of the exit lens 216, the rays of construction considered diverge from or converge toward the axis of the cylinder of the wave surface (for the real rays, convergent or divergent respectively).

The cross product of the vectors derived from the point P(u,h) with respect to u and with respect to h generates a vector orthogonal to the surface of the exit lens 216:

$$\frac{\partial \vec{OP}}{\partial u} ⋀ \frac{\partial \vec{OP}}{\partial h} ( u , h )$$

This normal vector can be calculated using the properties of the section of the exit lens 216 and the functions x_{M}(u), y_{M}(u) and z_{M}(u). With reference to FIG. 4, it thus appears that:

sin(η)=n sin(ξ)=n sin(η−r)=n(sin(η)cos(r)−cos(η)sin(r))

from which: tan(η)=n(tan(η)cos(r)−sin(r)) and
n(cos(r)−1)tan(η)=n(sin(r))

This equation therefore makes it possible to determine the angle η as a function of the height h. It is then possible to calculate the vectors derived from the space curve P(u,h) with respect to u and with respect to h, notably by considering the angle θ defined as:

$$θ = \frac{π}{2} + η$$

Thus:

$$\frac{\partial \vec{OP}}{\partial h} = cos ( θ ) \vec{χ} + sin ( θ ) \vec{V}$$

$$and$$

$$\frac{\partial \vec{OP}}{\partial u} = {\vec{t}}_{c} + ( h + dh ) \frac{d \vec{V}}{d u} ( ρ + dx - E ) \frac{d \vec{χ}}{d u}$$

This equation can be developed using the vectors \vec{t}_{c}, \vec{χ} and \vec{V} by considering the writing of their derivatives according to the following formulae:

$$\frac{d \vec{χ}}{d u} = \frac{1}{\sqrt{{x}_{M}^{′2} + {y}_{M}^{′2}}} \{ [ \begin{matrix}- {y}_{M}^{″} \\ {x}_{M}^{″ } \\ 0\end{matrix} ] - \frac{{x}_{M}^{′} {x}_{M}^{′′} + {y}_{M}^{′} {y}_{M}^{″}}{{x}_{M}^{′2} + {y}_{M}^{′2 }} [ \begin{matrix}- {y}_{M}^{′} \\ {x}_{M}^{′ } \\ 0\end{matrix} ] \}$$

$$\frac{d \vec{V}}{d u} = \frac{1}{\sqrt{( {x}_{M}^{′2} + {y}_{M}^{′2} ) ( {x}_{M}^{′2} + {y}_{M}^{′2} + {z}_{M}^{′2} )}} ( [ \begin{matrix}- {z}_{M}^{′′} {x}_{M}^{′} - {z}_{M}^{′} {x}_{M}^{″} \\ - {z}_{M}^{″} {y}_{M}^{′} - {z}_{M}^{′} {y}_{M}^{″} \\ 2 {x}_{M}^{″} {x}_{M}^{′} + 2 {y}_{M}^{′} {y}_{M}^{″}\end{matrix} ] - A [ \begin{matrix}- {z}_{M}^{′} {x}_{M}^{′} \\ - {z}_{M}^{′} {y}_{M}^{′} \\ {x}_{M}^{′2} + {y}_{M}^{′2}\end{matrix} ] )$$

Where

$$A = \frac{\begin{matrix}( {x}_{M}^{′} {x}_{M}^{″} + {y}_{M}^{′} {y}_{M}^{″} ) ( {x}_{M}^{′2} + {y}_{M}^{′2} + {z}_{m}^{′2} ) + \\ ( {x}_{M}^{′2} + {y}_{M}^{′2} ) ( {x}_{M}^{′} {x}_{M}^{″} + {y}_{M}^{′} {y}_{M}^{″} + {z}_{M}^{′} {z}_{M}^{″} )\end{matrix}}{( {x}_{M}^{′2} + {y}_{M}^{′2} ) ( {x}_{M}^{′2} + {y}_{M}^{′2} + {z}_{M}^{′2} )}$$

On the basis of Descartes' laws, it is then possible to determine the direction, along a vector \vec{μ}, of the ray refracted at P from an incident ray the direction of which is given by the vector \vec{j} determined previously.

The intersection of the refracted ray (P, \vec{μ}) with the entrance face of the exit lens 216 is then determined in two steps by means of coordinates of \vec{μ} established in the local reference frame. More precisely:

$${μ}_{x} = \vec{μ} \cdot \vec{χ}$$

$${μ}_{V} = \vec{μ} \cdot \vec{V}$$

$${μ}_{t} = \vec{μ} \cdot \frac{{\vec{t}}_{c}}{{‖ {\vec{t}}_{c} ‖}_{c}}$$

In such a way that:

$$\vec{μ} = {μ}_{x} \cdot \vec{χ} + {μ}_{V} \cdot \vec{V} + {μ}_{t} \frac{{\vec{t}}_{c}}{‖ {\vec{t}}_{c} ‖}$$

At first, the desired intersection is considered as a point I(u′,h′) situated at a distance λ from P, in the plane perpendicular to the style curve at M(u′), which makes it possible to establish a function λᵤ(u′).

I=P+λᵤ(u′)\vec{μ}

In such a way that \vec{MI}=\vec{MP}+λᵤ\vec{μ}

For a point u corresponding to the section of the entrance face containing I(u′,h′), the vector (MI{right arrow over ())} is perpendicular to the space curve 106 in such a way that:

\vec{MI}·\vec{t}_{c}=0

and that \vec{MP}·\vec{t}_{c}+λᵤ\vec{μ}·\vec{t}_{c}=0

i.e. \vec{MP}·\vec{t}_{c}+λᵤμₜ∥\vec{t}_{c}∥=0

Which makes it possible to determine the parameter λᵤ(u′).

Secondly, in the reference frame of construction at u′, it is considered that I belongs to the circle of radius Rᵢ and of center situated at E-Rᵢ on the axis \vec{χ}(u′), which makes it possible to successively determine u′, λᵤ, h′ and I.

In the local reference frame, the coordinates of I are:

\vec{MP}·\vec{χ}+λᵤμₓ

\vec{MP}·\vec{V}+λᵤμ_{V}

0

From that point, the fact that I belongs to the circle indicated translates into the following equation:

(\vec{MP}·\vec{χ}+λᵤμₓ−(Rᵢ−E))²+(\vec{MP}·\vec{V}+λᵤμ_{V})²=Rᵢ²

Solving this equation makes it possible to define the parameter u of the interface I while the parameter h is given by:

h=\vec{MP}·\vec{V}+λᵤμ_{V}

The value of u is determined such that:

\vec{MP}·\vec{χ}+λᵤχ_{χ}(Ri−E

Now |\vec{MP}·\vec{χ}+λᵤμ_{χ}−(Rᵢ−E)|=\sqrt{Rᵢ²−h²}

From which \vec{MP}·\vec{χ}+λᵤμ_{χ}−(Rᵢ−E)=−\sqrt{Rᵢ²−h²}

A special case appears when the refracted ray is in the plane of construction at u, which translates into:

\sqrt{MP}·\vec{t}_{c}=0

μₜ=0
\vec{μ} being in the plane of construction P.
λᵤ is then determined from the equation:

λᵤ²+2λᵤ(μ_{V}\vec{MP}·\vec{V}+μₓ(\vec{MP}·\vec{χ}−(Rᵢ−E)))+(\vec{MP}·\vec{V})²+(\vec{MP}·\vec{χ}−(Rᵢ=E))²=Rᵢ²

### Determination of the Entrance Face of the Lens:

If I(u,h) is a point on the entrance face of the exit lens 216, the cross product between the derivative of the vector \vec{OI} with respect to u and h generates a vector \vec{η}_{I} normal to the entrance surface of the exit lens 216 at I. With reference to FIG. 5, it is then possible to write:

I=M(u)−(E−ρ)·\vec{χ}+h·\vec{V}

It is therefore possible to write that

$$\frac{\partial \vec{OI}}{\partial h}$$

is the tangent, in I of the plane containing M and perpendicular to \vec{t}_{c}, which translates into:

$$\frac{\partial O \vec{I}}{\partial h} = sin ( α ) \cdot \vec{χ} + cos ( α ) \cdot \vec{V}$$

$$and$$

$$\frac{\partial O \vec{I}}{\partial u} = {\vec{t}}_{c} - ( E - ρ ) \frac{d \vec{χ}}{d u} + h \frac{d \vec{V}}{d u}$$

From this equation of the normal vector and from the preceding result, it is possible to propagate the ray (P, \vec{μ}) through the exit lens 216 according to Descartes' laws (FIG. 7) and obtain the inverse ray (I(u′,h′),\vec{ε}) emerging from the exit lens 216 in the direction of the reflector.

By naming S the point of intersection of (I(u′,h′),\vec{ξ}) with the reflector and d the distance from S to I(u′,h′), it appears that the constancy of the optical path K, independent of (u,h) for the trajectory from F to the axis of the exit wave surface passing through S, I(u′,h′) and P, makes it possible to establish d as a function of u, h and K and therefore finally S(u,h,K). More precisely:

S=I+d·\vec{ε} and

P̅C̅=signum(x_{c}−xₚ)\sqrt{(x_{c}−xₚ)²+(y_{c}−yₚ)²}

Let F be a focal point of the system, it then appears that:

FS+d+nλₐ+ P̅C̅=K

From which (FS)²=(K−d−nλₐ− P̅C̅)²

And if one sets K−d−nλₐ=k:

FI²+2\vec{FI}·\vec{ε}+d²=k²−2dk+d²

And 2(\vec{FI}·\vec{ε}+k)·d=k²−2FI²

This last equation makes it possible to obtain d and S.

In some cases, \vec{ε} does not exist following total internal reflection. In this case, it is nonetheless possible to calculate a hypothetical emergent ray, following the limit direction, in order to complete the mesh topology of the reflector and to be able to import it more easily into computer assisted design (CAD).

In other words, a radius \vec{ε} is used perpendicular to \vec{η}_{I} and contained in the plane (\vec{η}_{I}, \vec{μ}) in such a way that this radius \vec{ε} is collinear with the vector originating from the cross product:

\vec{η}_{I}̂\vec{μ} [symbol] \vec{η}_{I}

It is possible to determine K and to obtain a parametric equation of the reflector S(u,h) by writing that xₛ(u_{median}, 0, K)=x_{F}−f where f is a pseudo-focal length for the reflector.

The present invention is suitable for many variants, for example relating to the light source 212 and to its direction of lighting. In this description, it is indeed considered that the dimensions of the headlamp housing 102 are limited due to imperatives of motor vehicle construction. The result is that the light source 212 is relatively close to the outer lens 216 which risks being subjected to excessive heating, notably with an outer lens 216 made of transparent plastic material and a light source of the halogen lamp type. To avoid such difficulties, the light source 212 is a light-emitting diode but other light sources could be employed.

Moreover, it can be considered in one embodiment that the light source 212 radiates toward a reflector 214 situated in a plane beneath the light source 212 but, in other variants, the reflector 214 can be situated in distinct positions vis-a-vis the light source 212. Notably, the construction method indicated previously provides the information that the relative position of the light source 212 and of the reflector 214 depend on the position of the focal point F with respect to the exit lens 216. For example, if the focal point F is situated above the exit lens 216 in front view, the reflector 214 is found below the focal point F while, if the focal point F is situated below the exit lens 216 in front view, the reflector 214 is found above F.

FIG. 12 represents the overall lens 104 in FIG. 2, seen from another angle. It can be observed that this overall lens 104 has a curved shape along various curvatures. Its shape follows a space curve 106. Behind it is situated an assembly of three reflectors 214 associated with 3 LEDs or light sources 212. In this figure are shown two identical sections 104a and 104b (dotted lines alternating a short line and a long line). These are identical sections in various planes of construction defined in such a way that each plane of construction, comprising a point M of the space curve 106, is perpendicular to a vector tangent (\vec{t}_{c}) to the space curve 106, as defined previously, notably for FIG. 2.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A module of a headlamp for a motor vehicle, this module comprising a concave reflector, a light source arranged in a concave region of the reflector and an exit lens exhibiting a median line on its exit surface forming a space curve, wherein the exit lens and the reflector are arranged in such a way that a light beam reflected by the reflector is directly refracted by the exit lens in such a way as to generate a beam of light for lighting the road.

2. The module as claimed in claim 1, wherein the exit lens and the reflector are arranged in such a way that the light beam directly refracted by the lens forms a cylindrical wave surface.

3. The module as claimed in claim 1, wherein the exit lens and the reflector are arranged in such a way that the position of the axis (C) of a cylindrical wave surface of the directly refracted light beam determines a height and an aperture of said directly refracted light beam.

4. The module as claimed in claim 3, wherein the reflector and the lens form a system with a focal point (F), said reflector being arranged in such a way that, for any given point (S) of the reflector, the optical path (K) up to the axis (C) of said cylindrical wave surface corresponding to a ray coming from said focal point (F) passing through this given point (S) of the reflector then emerging at a point (P) on the exit surface of the lens, is constant.

5. The module as claimed in claim 1, wherein the directly refracted light beam is a beam of high beam type.

6. The module as claimed in claim 1, wherein the exit lens exhibits a vertical section that is variable along the space curve.

7. The module as claimed in claim 1, wherein the exit lens exhibits identical sections on various planes of construction defined such that each plane of construction, comprising a point M on the space curve, is perpendicular to a vector (\vec{t}_{c}) tangent to said space curve.

8. The module as claimed in claim 1, wherein the reflector and the light source are arranged in such a way that a beam of light coming from the light source is directly reflected by the reflector toward the lens.

9. An elementary optical lens able to be used as the exit lens of a module as claimed in claim 1, said lens comprising an exit surface following a space curve median, sections of the lens at several points (M) on this space curve median in planes perpendicular to the space curve median being superimposable by translational and/or rotational movement without deformation.

10. The elementary optical lens as claimed in claim 9, wherein it forms a stigmatic optical system in the various planes perpendicular to the space curve median.

11. The elementary optical lens as claimed in claim 9, wherein it exhibits a spherical entrance surface of constant radius (Ri) in the various planes perpendicular to the space curve median.

12. A module as claimed in claim 1, wherein the exit lens is an elementary optical lens comprising an exit surface following a space curve median, sections of the lens at several points (M) on this space curve median in planes perpendicular to the space curve median being superimposable by translational and/or rotational movement without deformation.

13. An optical lens with portions formed by a plurality elementary optical lenses in accordance with claim 9.

14. The optical lens with portions as claimed in claim 13 comprising an overall exit face:
formed by exit faces of various elementary optical lenses, and
comprising an overall median curve formed by the median curves of the various elementary lenses.

15. The optical lens with portions as claimed in claim 14, in which the overall exit surface is continuous and smooth.

16. A headlamp for a motor vehicle generating a light beam, in particular a high beam, wherein it comprises at least two lighting modules, as claimed in claim 1, juxtaposed in such a way that the overall lens of the headlamp, formed by the juxtaposition of the exit lenses of the modules, follows a space curve.

17. The headlamp as claimed in claim 16, in which the overall lens is an optical lens with portions formed by a plurality elementary optical lenses.

18. The module as claimed in claim 2, wherein the exit lens and the reflector are arranged in such a way that the position of the axis (C) of the cylindrical wave surface of the directly refracted light beam determines a height and an aperture of said directly refracted light beam.

19. The module as claimed in claim 2, wherein the directly refracted light beam is a beam of high beam type.

20. The module as claimed in claim 2, wherein the exit lens exhibits a vertical section that is variable along the space curve.
